(19) United States
(12) Patent Application Publication
(10) Pub. No.: US 2004/0021290 A1
(43) Pub. Date: Feb. 5, 2004

(54) Integrated fifth wheel and frame suspension

(76) Inventors: William J. Hicks, Muskegon, MI (US); Roger L. Elkins, Rockford, MI (US); Steven C. Dupay, Holland, MI (US); Mark M. Audo, Muskegon, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/297,780

(22) PCT Filed: Jun. 7, 2001
(86) PCT No.: PCT/US01/18437

(51) Int. Cl. B62D 53/06

(52) U.S. Cl. 280/438.1

(57) ABSTRACT

An integrated fifth-wheel hitch and axle suspension assembly for mounting on a truck with a pair of spaced apart frame rails comprises a fifth-wheel hitch carriage adapted for mounting a fifth-wheel hitch, a pair of suspension brackets for mounting an axle suspension component and an integrating connector rigidly connecting the fifth-wheel hitch carriage to the suspension brackets at opposite sides of the hitch carriage. The integrating connector, the hitch carriage and the suspension brackets define an elongated opening for slidably receiving the truck frame rails so that the integrated fifth-wheel hitch and axle suspension assembly can slide as a unit onto the truck frame rails. An integrated connection interface includes a plurality of electronic and pneumatic connectors in a connector harness for selectively connecting electronic and pneumatic systems on a truck with electronic and pneumatic components of an integrated fifth-wheel hitch and axle suspension assembly.

### BACKGROUND OF THE INVENTION

1. Field of the Invention

The invention relates to fifth-wheel hitch and frame suspensions for truck frames. In one of its aspects, the invention relates to an integrated fifth wheel hitch and frame suspension. In another of its aspects, the invention relates to a modular assembly that integrates a fifth-wheel hitch and truck trailing arm suspension for installation in a truck frame as an integral unit. In another of its aspects, the invention relates to subassemblies of a fifth-wheel hitch and assembled suspension components for installation in a truck frame as a unit. In another of its aspects, the invention relates to a truck with an integrated fifth wheel hitch and axle suspension.

2. Description of the Related Art

Truck manufacturers assemble individual components or subassemblies on the vehicle frame. These installations require that the system be built up piece-by-piece from components including a fifth-wheel hitch assembly, vehicle suspension components including frame brackets, electrical harness and connections to the vehicle electrical system, and pneumatic system components and connections such as for brake and height control systems. The installation can be time-consuming and cost-ineffective, and can face issues of system incompatibilities.

U.S. Pat. No. 3,580,611, issued May 25, 1971, to McNitt, discloses a fifth wheel support platform for installation on a truck tractor, wherein the tractor is prepared for installation of the support platform by the vehicle manufacturer. Spring brackets are installed on the tractor side rails. The brackets include an offset upper portion that creates a gap designed to accommodate a depending flange of the fifth wheel support platform.

U.S. Pat. No. 5,449,191, issued Sep. 12, 1995, to Cattau, discloses a fifth wheel slide assembly, including a plate mountable onto parallel truck frame rails. The assembly includes a fifth-wheel hitch that is adjustable for the purpose of distributing load on the truck frame, and the hitch is assisted in rolling by rollers that project through apertures in the plate.

It would be advantageous, reducing installation time and system incompatibilities, to provide an integrated assembly of a fifth-wheel hitch and suspension frame brackets that can be installed on a truck frame as a unit. It would further be desirable to include electrical and pneumatic systems in the integrated assembly.

### SUMMARY OF THE INVENTION

According to the invention, an integrated fifth-wheel hitch and axle suspension assembly for mounting on a truck with a pair of spaced apart frame rails comprises a fifth-wheel hitch carriage adapted for mounting a fifth-wheel hitch, a pair of suspension brackets for mounting an axle suspension component and an integrating connector rigidly connecting the fifth-wheel hitch carriage to the suspension brackets at opposite sides of the hitch carriage. The integrating connector, the hitch carriage and the suspension brackets define an elongated opening for slidably receiving the truck frame rails so that the integrated fifth-wheel hitch and axle suspension assembly can slide as a unit onto the truck frame rails.

Further according to the invention, a truck with a pair of spaced-apart frame rails has an integrated fifth-wheel hitch and axle suspension assembly comprising a fifth-wheel hitch carriage mounting a fifth-wheel hitch, a pair of suspension brackets mounting an axle suspension component, and an integrating connector rigidly connecting the fifth-wheel hitch carriage to the suspension brackets at opposite sides of the hitch carriage. The integrating connector, the hitch carriage and the suspension brackets define an elongated opening slidably received on the truck frame rails and are rigidly connected thereto.

In one embodiment, the integrating connector comprises a rail plate mounted to each side of the fifth-wheel hitch carriage, each of the rail plates mounting one of the suspension brackets. In another embodiment of the invention, the integrating connector comprises a cross-member extending between the suspension brackets.

In the first embodiment, the elongated opening is defined by the rail plates and the fifth-wheel hitch carriage. In a second embodiment, the elongated opening comprises a pair of frame rail slots formed between the cross member and the suspension brackets.

Further, a fifth-wheel hitch is mounted to the fifth-wheel hitch carriage. The suspension component is preferably a trailing arm for mounting an axle and pivotally mounted to each of the pair of suspension brackets. Preferably, an air spring is connected to each trailing arm and to the integrating connector or to the rails. Further, a shock absorber can be connected to each trailing arm and to the integrating connector or to the rails.

In one embodiment, pneumatic components are carried by the hitch carriage and the suspension brackets and an integrated pneumatic interface having a single connector harness is connected to the pneumatic components for selectively connecting a pneumatic system on the truck and the pneumatic components of the integrated fifth-wheel hitch and axle suspension assembly.

In another embodiment, electronic components are carried by the hitch carriage and the suspension brackets and an integrated electronic interface having a single connector harness is connected to the electronic components for selectively connecting an electronic system on the truck and electronic components of the integrated fifth-wheel hitch and axle suspension assembly.

Further according to the invention, an integrated fifth-wheel hitch and axle suspension assembly for mounting on a truck with a pair of spaced apart frame rails comprises a fifth-wheel hitch carriage adapted for mounting a fifth-wheel hitch, a pair of suspension brackets for mounting an axle suspension component and an integrating connector rigidly connecting the fifth-wheel hitch carriage to the suspension brackets at opposite sides of the hitch carriage. Electronic and/or pneumatic components are carried by the fifth-wheel hitch carriage and the suspension brackets. A connector harness that includes a plurality of electronic and pneumatic connectors is connected to the electronic and/or pneumatic components to form an integrated connection interface for selectively connecting electronic and pneumatic systems on a truck with the electronic and/or pneumatic components of the an integrated fifth-wheel hitch and axle suspension assembly.

### BRIEF DESCRIPTION OF THE DRAWINGS

In the drawings:

FIG. 1 is a perspective view of an integral fifth-wheel hitch and frame suspension assembly according to a first embodiment of the invention received within the parallel rails of a truck frame.

FIG. 2 is a perspective view of the integral fifth-wheel hitch and frame suspension assembly of FIG. 1.

FIG. 3 is a rear view of the assembly of FIGS. 1 and 2.

FIG. 4 is a cross-sectional view taken along line 4-4 of FIG. 3.

FIG. 5 is a cross-sectional view taken along line 5-5 of FIG. 4.

FIG. 6 is a schematic diagram of a pneumatic and electronic interface of the integral fifth-wheel hitch and frame suspension assembly of FIG. 1.

FIG. 7 is a perspective view of an integral fifth-wheel hitch and frame suspension assembly according to a second embodiment of the invention.

FIG. 8 is perspective view of the integral fifth-wheel hitch and frame suspension assembly of FIG. 7 mounted on a truck frame.

FIG. 9 is a side view of the integral fifth-wheel hitch and frame suspension assembly of FIGS. 7 and 8 mounted on the truck frame.

FIG. 10 is a rear view of the assembly of FIGS. 8 and 9.

FIG. 11 is a plan view of the assembly of FIGS. 8 and 9.

### DESCRIPTION OF THE PREFERRED EMBODIMENT

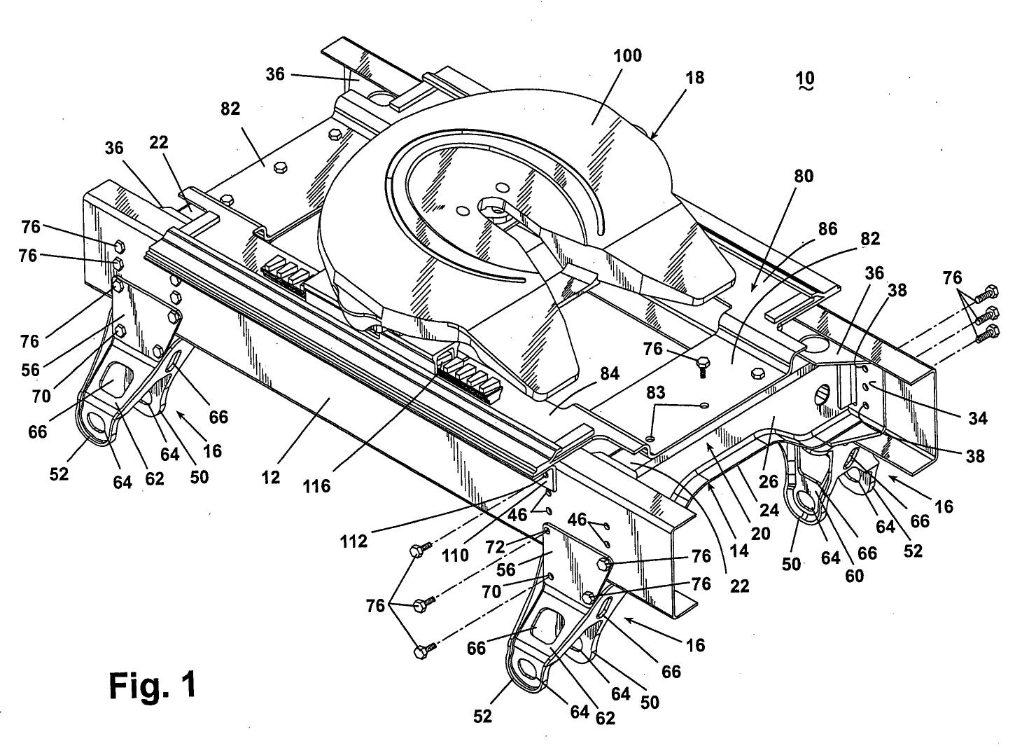

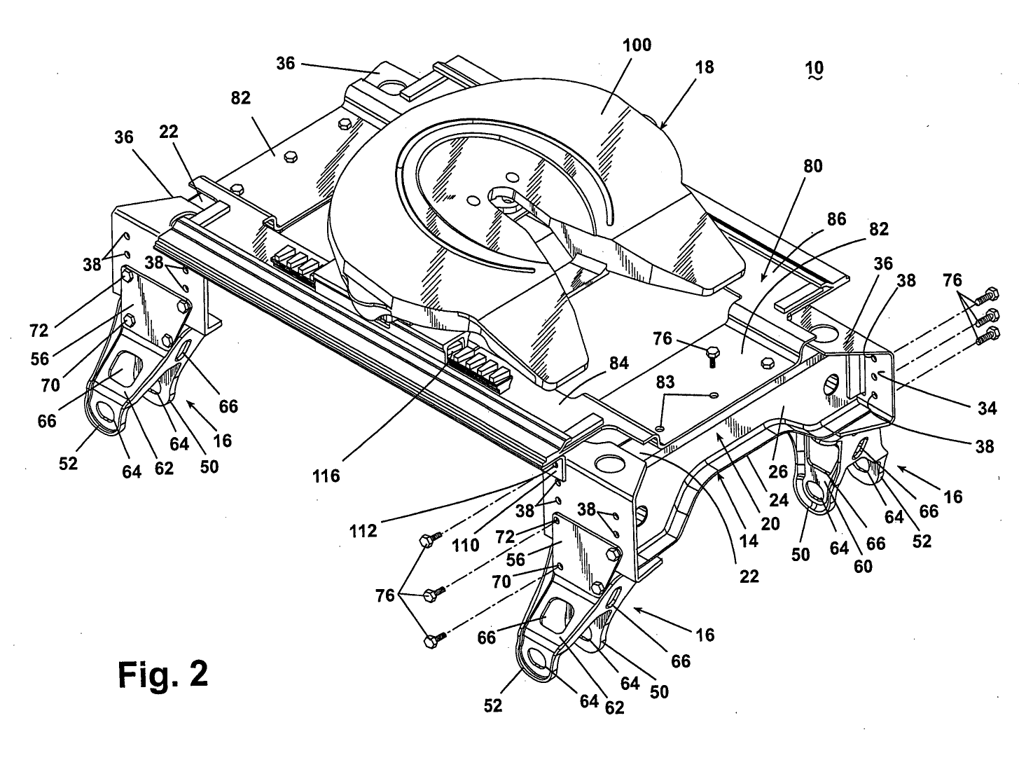

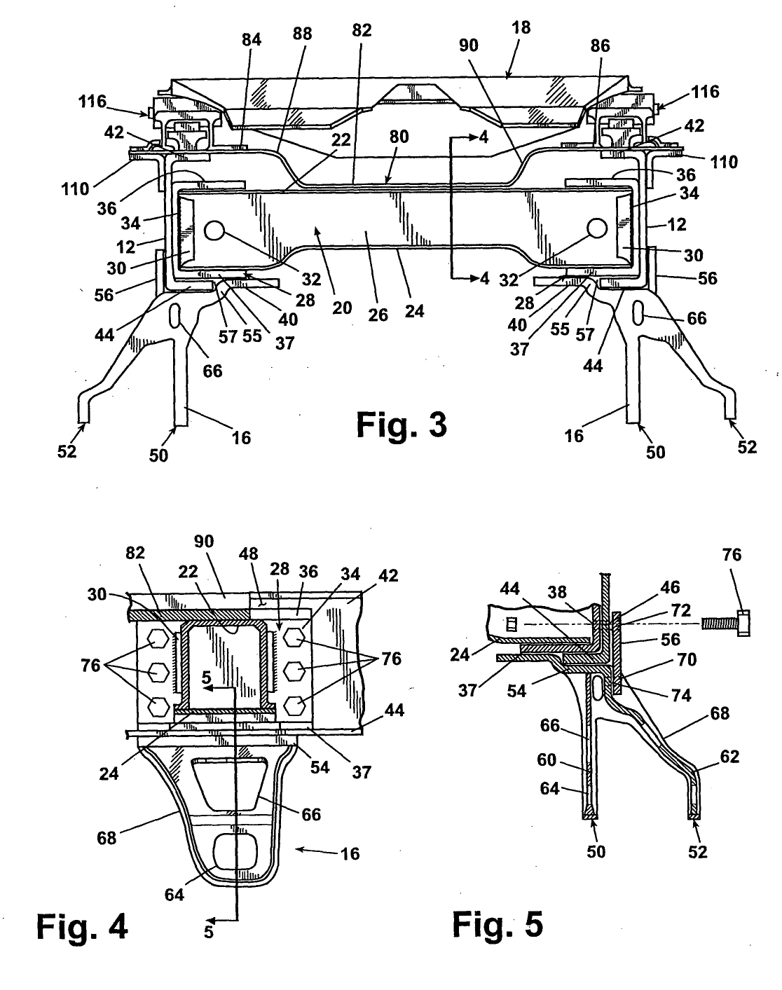

Referring now to the drawings and to FIGS. 1-5 in particular, a fifth wheel and frame suspension 10, for attaching to truck frame rails 12, comprises a cross member 14, at least one suspension bracket 16, and a fifth-wheel hitch assembly 18.

The cross member 14 comprises an inverted U-channel 20, including upper web 22 and two side flanges 26. The cross member 14 further comprises a lower flange 24 fixed to the side flanges 26, such as by welding or other mechanical means, in a generally parallel relationship to the cross member web 22. The cross member 14 further comprises a pair of end caps 28 and a reinforcing gusset plate 30 affixing the end caps 28 to the side flanges 26 of the cross member 14. Each end cap 28 comprises a section of U-channel having an end cap web 34 and end cap flanges 36, a plurality of fastener apertures 38 being formed in the end cap web 34. The cross member 14 further comprises a plurality of apertures 32 formed in each side flange 26, proximate each end cap 28 and aligned with a corresponding aperture 32 on the opposing side flange 26.

Truck frame rails 12 are parallel inwardly facing U-channels comprising a rail web 40, an upper flange 42, and a lower flange 44. Rail web 40 further comprises a plurality of fastener apertures 46 passing therethrough for alignment with fastener apertures 38 of the end cap 28.

Suspension bracket 16 comprises a suspension bracket inner leg 50, a suspension bracket outer leg 52, and a suspension bracket upper portion 54. Suspension bracket inner leg 50 comprises an inner leg web 60 including a suspension mounting aperture 64 and a supplemental aperture 66 passing therethrough. The suspension bracket outer leg 52 comprises an outer leg web 62 having a suspension mounting aperture 64 and supplemental aperture 66 passing therethrough. Suspension mounting apertures 64 of the inner and outer leg webs 60, 62 are aligned. The suspension bracket 16 further comprises a common flange 68 passing about the exterior of the bracket and affixed to the inner leg web 60 and outer leg web 62 by welding or other mechanical means. The common flange 68 further includes supplemental aperture 66. The suspension bracket 16 further comprises an outer mounting plate 56 having mounting plate bracket apertures 70 and mounting plate rail apertures 72. The outer leg web 62 further comprises bracket plate apertures 74 passing therethrough.

Fifth-wheel hitch assembly 18 comprises a fifth-wheel hitch carriage 80 comprising central recessed portions 82 and parallel first and second longitudinal rail portions 84, 86. Rail portions 84, 86 are co-planar and are received on the upper flanges 42 of truck frame rails 12. Recessed portions 82 are planar and parallel to first and second rail portions 84, 86, and are integral therewith through first and second transition portions 88, 90. Recessed portions 82 further comprise apertures 83 for alignment with fastener apertures (not shown) in cross member upper web. 22, for receiving mechanical fasteners such as bolts 76 to secure carriage 80 to cross members 14. Fifth wheel carriage 80 further comprises longitudinal angle brackets 110 having fastener apertures 112. Fifth-wheel hitch assembly 18 further comprises a slidable low-profile fifth-wheel hitch 100 having adjustment rails 116 mounted on first and second rail portions 84, 86. Hitch 100 and adjustment rails 116 are common in fifth wheel assemblies.

One of the suspension brackets 16 is affixed to each end of cross member 14. Upper portion 54 is affixed, by welding or mechanical fasteners, to lower flange 24 of the cross member 14 and lower end cap flange 37. Upper portion 54 of suspension bracket 16 includes an offset region 55. Upper portion 54 and end cap flange 37, when assembled, define a gap 57 for receiving rail lower flange 44. At least a second cross member 14 is likewise assembled with suspension brackets 16. Recessed portion 82 of fifth wheel carriage 80 is mounted to web 22 of cross member 14 by welding or other mechanical fasteners, holding cross members 14 in a fixed spacing parallel to each other and perpendicular to rail portions 84, 86.

The fifth wheel and flame suspension 10, comprising the fifth-wheel hitch assembly 18, at least two cross members 14, and suspension brackets 16 is mounted within truck rails 12 by sliding the assembly longitudinally between the truck rails 12. End caps 28 slide within truck flame rails 12, with each rail lower flange 44 residing in gap 57 between bracket upper portion 54 and end cap lower flange 37. End cap lower flanges 37 are thereby kept flush against rail lower flange 44 so that a gap 48 is formed between end cap flange 36 and rail upper flange 42. Carriage 80 is configured such that transition portions 88, 90 offset rail portions 84, 86 above recessed portion 82 to place rail portions 84, 86 in flush contact with the upper surface of rail upper flanges 42. Carriage 80 is thereby supported by rail upper flanges 42 and cross members 14, which are in turn supported at end caps 28 by suspension brackets 16. Rail lower flanges 44 are further supported by bracket upper portions 54.

With the fifth wheel and flame suspension 10 in place within the frame rails 12, apertures 38 align with apertures 46 in rail webs 40 for receiving a mechanical fastener such as a bolt 76, which is tightened to provide mechanical fastening. Further, bracket-plate apertures 74 are aligned with apertures 46 to correspond to the layout of apertures 70, 72 of outer mounting plate 56, so that outer mounting plate 56 is received against outer leg web 62 with mounting plate bracket apertures 70 aligned with bracket-plate apertures 74, and mounting plate rail apertures 72 aligned with truck frame rail apertures 46, for receiving a mechanical fastener such as bolts 76. Apertures 112 in angle bracket 110 are further aligned with apertures 46 in rail web 40 for receiving mechanical fasteners. Fifth wheel and frame suspension 10 is thus secured to frame rails 12 by mechanical fasteners securing end caps 28 to rail webs 40, and suspension brackets 16 to rail webs 40 through outer mounting plates 56. Carriage 80 is further secured to rails 12 through angle bracket 110. Whereas securing the fifth wheel and suspension 10 to rails 12 has been described as using mechanical fasteners passed through aligned apertures in the respective components, it is contemplated that other methods of securing, such as welding, can be used within the scope of the invention.

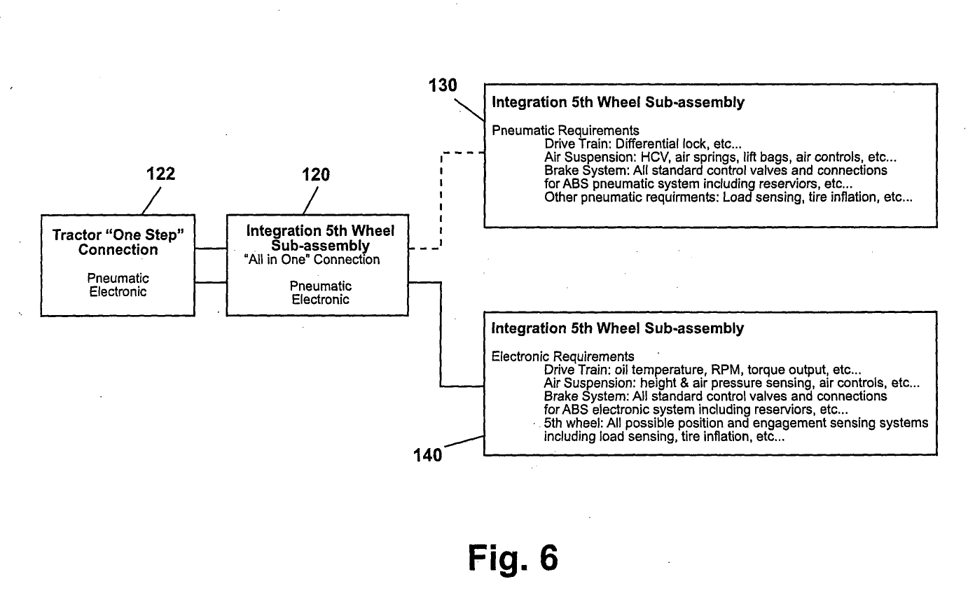

The integral fifth wheel and frame suspension assembly 10 further encompasses an integrated pneumatic and electronic plug interface 120 pre-configured to be aligned with, and provide expeditious connection to, the pneumatic and electronic systems of the base vehicle, as shown in FIG. 6. The base vehicle is provided with a matching connector 122, for receiving the integrated plug interface 120. The integrated plug interface 120 provides connectors for such pneumatic requirements 130 as the drive train differential lock, air suspension components, brake system components, and other pneumatic requirements such as load sensing and tire inflation. The integrated plug interface 120 provides connectors for such electronic requirements 140 as drive sensors (oil temperature, RPM, torque output), air suspension height and air pressure sensors, air controls), brake system components (control valves and connections for ABS system including reservoirs), and fifth wheel position and engagement sensing systems, load sensing, and tire inflation The integrated plug interface 120 is further anticipated to contain other pneumatic and electronic systems connecting the base vehicle and the integral fifth wheel and frame suspension assembly 10 as known to those of ordinary skill in the art.

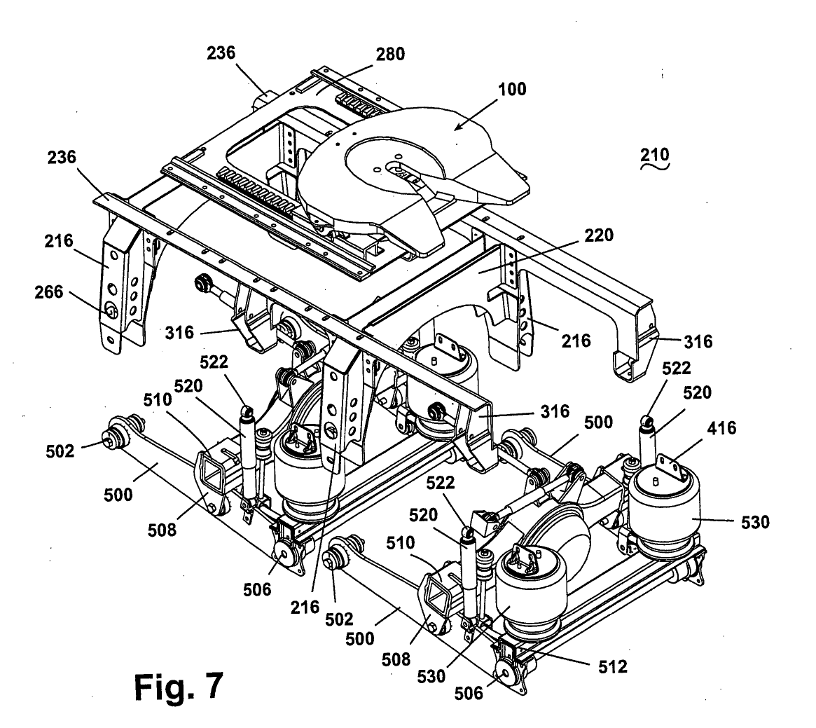

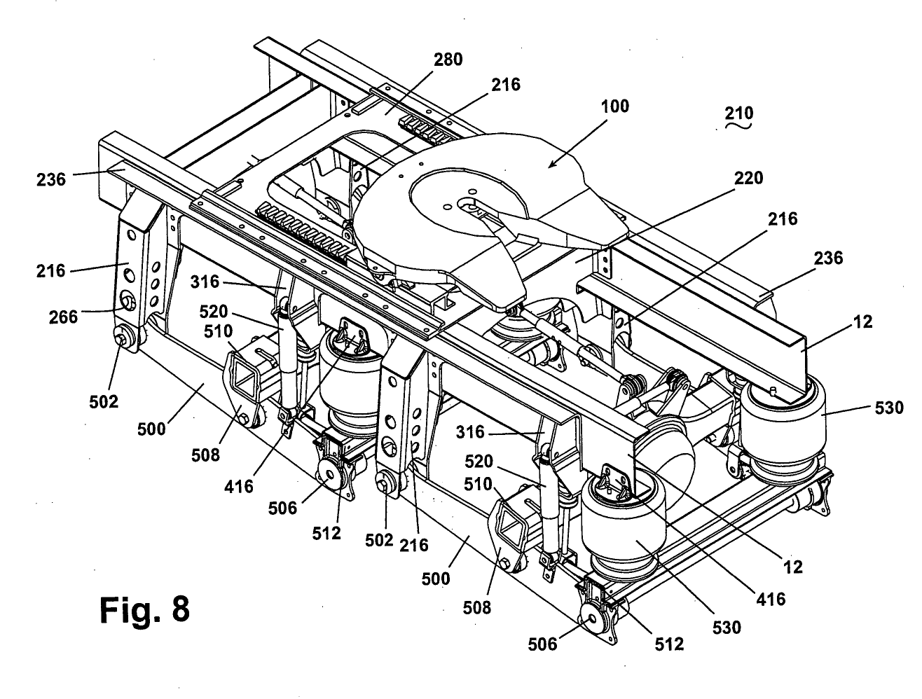

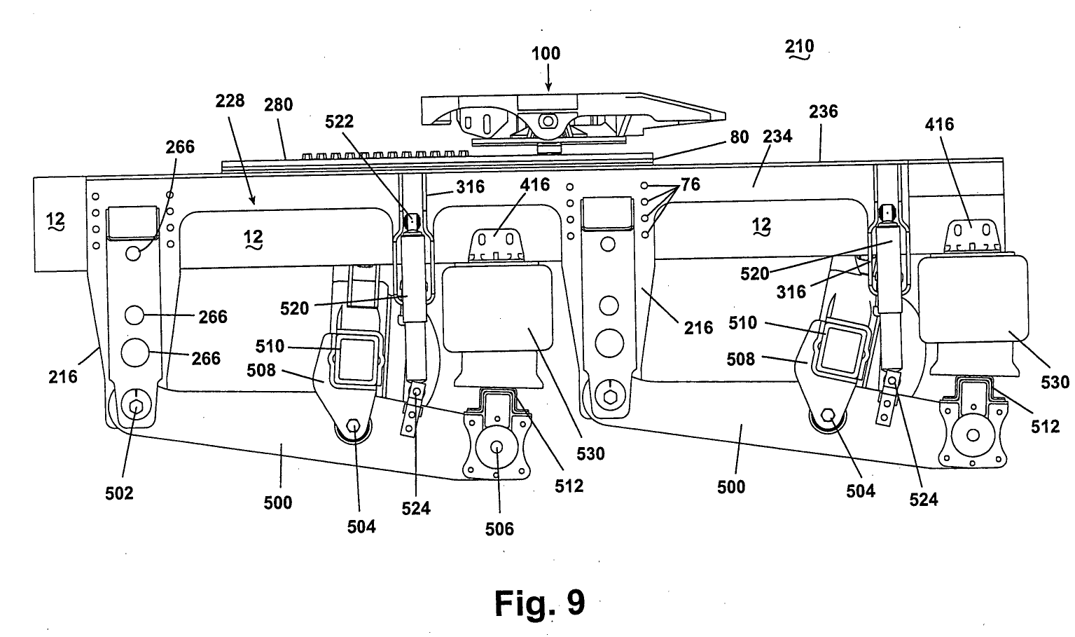

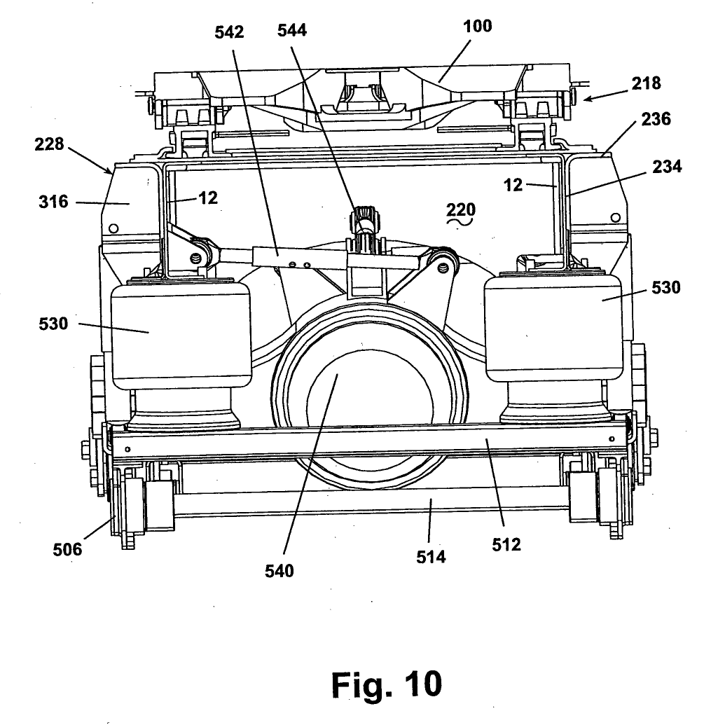

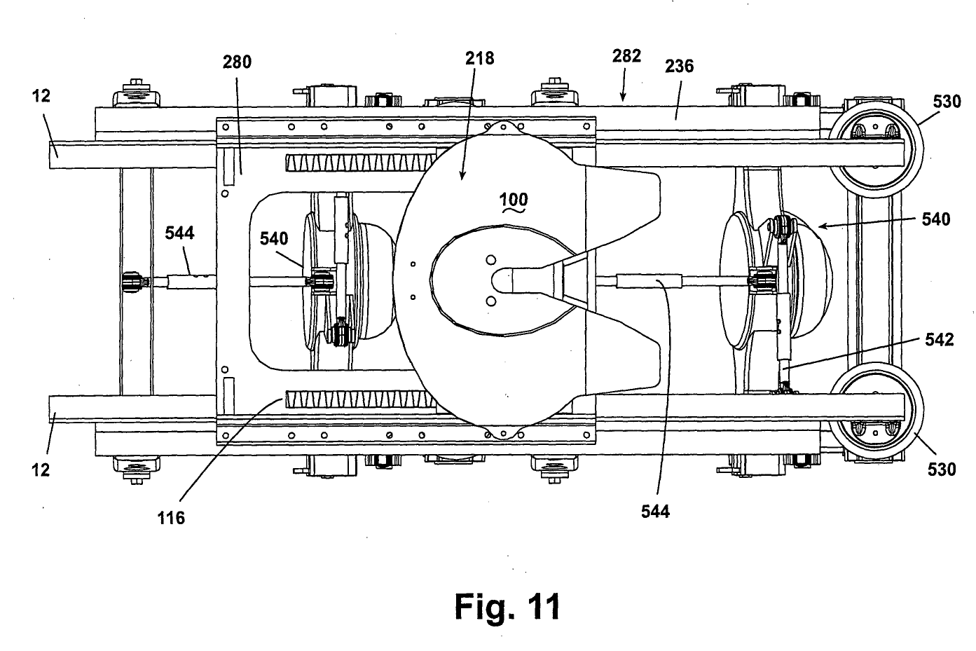

A second embodiment of the integrated fifth-wheel hitch assembly is shown in FIGS. 7-11 in which like numerals have been used to designate like parts. In this embodiment, a cross member 220 extends between and rigidly connects the truck frame rails 12. The integrated fifth wheel frame assembly 210 is configured to be lowered over the truck frame rail, or in instances where suspension components are pre-installed, it may be necessary to slide the integrated fifth wheel frame assembly 210 longitudinally onto the truck frame rails 12 from the rear of the truck frame rails 12.

The integrated fifth wheel frame assembly 210 comprises a fifth wheel carriage 280 and a pair of rail plates 228 depending from the fifth wheel carriage 280. The rail plates 228 comprise an upper flange 236 and a rail plate web 234, first suspension bracket 216, second suspension bracket 316 and third suspension bracket 416. The carriage 280 and the rail plates 228 are rigidly joined together by welding or other suitable fasteners. A pair of cross members 220 extend between the suspension brackets 216 and are rigidly joined thereto. The cross members are bolted to the frame rails 12 when the frame assembly 210 is assembled onto the frame rails 12.

A trailing arm 500 is pivotally mounted at one end to a first suspension bracket 216 through a conventional trailing arm pivot 502. The trailing arm 500 pivotally mounts an axle housing 510 through an axle bracket 508 and a trailing arm drive axle pivot 504 at an intermediate portion of the trailing arm 500. The axle housing 510 carries an axle (not shown) and is part of a drive axle assembly 540. A trailing arm air spring brace 506 is mounted to another end portion of the trailing arm 500 and mounts a cross brace 512. Air springs 530 are mounted to the cross brace 512. The air springs 530 are connected between the third suspension bracket 416 and to the trailing arm cross brace 512. A torsion beam 514 is rigidly mounted at each end to the air spring brace 506.

A trailing arm shock absorber 520 has an upper shock mount 522 connected to the second suspension bracket 316 and a lower shock mount 524 connected to the trailing arm 500 through bracket 524.

This second embodiment of the integrated fifth wheel frame assembly provides the original equipment manufacturer the flexibility of utilizing its own truck frame construction and drive train. The original equipment manufacturer can then use the integrated fifth wheel and frame suspension without modifying the truck frame itself.

The embodiment of FIGS. 7-11 includes a trailing arm 500, an axle 510 and a air spring 530. Although not shown in FIGS. 1-5, these same components are typically mounted to the suspension brackets 16 and between the trailing arm and the frame in the same manner as they are mounted to the 516 in the embodiment of FIGS. 7-11.

While the invention has been specifically described in connection with certain embodiments thereof, it is to be understood that this is by way of illustration and not of limitation. Reasonable variation and modification are possible within the scope of the foregoing disclosure without departing from the spirit or gist of the invention.

What is claimed is:

1. An integrated fifth-wheel hitch and axle suspension assembly for mounting on a truck with a pair of spaced apart frame rails, comprising:
a fifth-wheel hitch carriage adapted for mounting a fifth-wheel hitch;
a pair of suspension brackets for mounting an axle suspension component;
an integrating connector rigidly connecting the fifth-wheel hitch carriage to the suspension brackets at opposite sides of the hitch carriage;
the integrating connector, the hitch carriage and the suspension brackets define an elongated opening for slidably receiving the truck frame rails so that the integrated fifth-wheel hitch and axle suspension assembly can slide as a unit onto the truck frame rails.

2. The assembly of claim 1 wherein the integrating connector comprises a rail plate mounted to each side of the fifth-wheel hitch carriage, each of the rail plates mounting one of the suspension brackets.

3. The assembly of claims 1 or 2 wherein the elongated opening is defined by the rail plates and the fifth-wheel hitch carriage.

4. The assembly of any of claims 1-3 and further comprising a fifth-wheel hitch mounted to the fifth-wheel hitch carriage.

5. The assembly of any of claims 1-4 and further comprising a trailing arm for mounting an axle pivotally mounted to each of the pair of suspension brackets.

6. The assembly of claim 5 and further comprising an air spring connected to each trailing arm and to each of the pair of suspension brackets.

7. The assembly claims 5 or 6 and further comprising a shock absorber connected to each trailing arm and to each of the pair of suspension brackets.

8. The assembly of claim 1 wherein the integrating connector comprises a cross-member extending between the suspension brackets.

9. The assembly of claim 8 wherein the elongated opening comprises a pair of frame rail slots formed between the cross member and the suspension brackets.

10. The assembly of claims 8 or 9 and further comprising a fifth-wheel hitch mounted to the fifth-wheel hitch carriage.

11. The assembly of any of claims 8-10 and further comprising a trailing arm for mounting an axle mounted to each of the pair of suspension brackets.

12. The assembly of any of claims 8-11 and further comprising an air spring connected to each trailing arm and to each of the pair of suspension brackets.

13. The assembly of claim 12 and further comprising a shock absorber connected to each trailing arm and to each of the pair of suspension brackets.

14. The assembly of any of claims 1-13 and further comprising pneumatic components carried by the hitch carnage and the suspension brackets and an integrated pneumatic interface having a single connector harness connected to the pneumatic components for selectively connecting a pneumatic system on the truck and pneumatic components of the integrated fifth-wheel hitch and axle suspension assembly.

15. The assembly of any of claims 1-14 and further comprising electronic components carried by the hitch carriage and the suspension brackets and an integrated electronic interface having a single connector harness connected to the electronic components for selectively connecting an electronic system on the truck and electronic components of the integrated fifth-wheel hitch and axle suspension assembly.

16. A truck with a pair of spaced-apart frame rails and an integrated fifth-wheel hitch and axle suspension assembly, comprising:
a fifth-wheel hitch carriage mounting a fifth-wheel hitch;
a pair of suspension brackets mounting an axle suspension component; and
an integrating connector rigidly connecting the fifth-wheel hitch carriage to the suspension brackets at opposite sides of the hitch carriage,
wherein the integrating connector, the hitch carriage and the suspension brackets define an elongated opening slidably received on the truck frame rails and are rigidly connected thereto.

17. The truck of claim 16 wherein the integrating connector comprises a rail plate mounted to each side of the fifth-wheel hitch carriage, each of the rail plates mounting one of the suspension brackets.

18. The truck of claim 17 wherein the elongated opening is defined by the rail plates and the fifth-wheel hitch carriage.

19. The truck of any of claims 16-18 wherein the suspension component comprises a trailing arm mounting an axle and mounted to each of the pair of suspension brackets.

20. The truck of claim 19 and further comprising an air spring connected to each trailing arm and to one of the frame rails.

21. The truck of any of claims 19 or 20 and further comprising a shock absorber connected to each trailing arm and to one of the frame rails.

22. The truck of claim 16 wherein the integrating connector comprises a cross-member extending between the suspension brackets.

23. The truck of claim 22 wherein the elongated opening comprises a pair of frame rail slots formed between the cross member and the suspension brackets.

24. The truck of any of claims 22 or 23 wherein the suspension component comprises a trailing arm mounting an axle and mounted to each of the pair of suspension brackets.

25. The truck of claim 23 and further comprising an air spring connected to each trailing arm and to one of the frame rails.

26. The truck of any of claims 24 or 25 and further comprising a shock absorber connected to each trailing arm and to one of the frame rails.

27. The truck of any of claims 16-26 and further comprising pneumatic components carried by the hitch carriage and the suspension brackets and an integrated pneumatic interface having a single connector harness connected to the pneumatic components for selectively connecting a pneumatic system on the truck to the pneumatic components of the integrated fifth-wheel hitch and axle suspension assembly.

28. The truck of any of claims 16-27 and further comprising electrical components carried by the hitch carriage and the suspension brackets and an integrated electronic interface having a single connector harness connected to the electrical components for selectively connecting an electronic system on the truck to the electronic components of the integrated fifth-wheel hitch and axle suspension assembly.

29. An integrated fifth-wheel hitch and axle suspension assembly for mounting on a truck with a pair of spaced-apart frame rails comprising:
a fifth-wheel hitch carriage adapted for mounting a fifth-wheel hitch:
a pair of suspension brackets for mounting an axle suspension component;
an integrating connector rigidly connecting the fifth-wheel hitch carriage to the suspension brackets at opposite sides of the hitch carriage;
electronic and/or pneumatic components carried by the fifth-wheel hitch carriage and the suspension brackets;
a connector harness including a plurality of electronic and/or pneumatic connectors connected to the electronic and/or pneumatic components to form an integrated connection interface for selectively connecting the electronic and/or pneumatic systems on a truck with the electronic and/or pneumatic components of the an integrated fifth-wheel hitch and axle suspension assembly.
